(19) United States
(12) Patent Application Publication
(10) Pub. No.: US 2024/0027027 A1
(43) Pub. Date: Jan. 25, 2024

(54) LIQUEFIED GAS STORAGE VESSEL FOR INTERMODAL TRANSPORT

(71) Applicant: REKTOR LNG d.o.o, HRVATSKA, PULA (HR)

(72) Inventor: Peranic JOSIP, CRIKVENICA (HR)

(73) Assignee: REKTOR LNG d.o.o, HRVATSKA, PULA (HR)

(21) Appl. No.: 17/621,456

(22) PCT Filed: Apr. 19, 2021
(86) PCT No.: PCT/HR2021/000004

§ 371 Date: Dec. 21, 2021

(51) Int. Cl. F17C 3/08

(52) U.S. Cl. CPC F17C 3/08; F17C 2223/0161; F17C 2203/0629; F17C 2203/0337; F17C 2203/0636; F17C 2203/066; F17C 2209/238; F17C 2201/0109; F17C 2203/0391; F17C 2203/014

(57) ABSTRACT

The liquefied gas tank for storage and distribution of liquefied gas is designed so that the outer 1 and inner tank 2 touch only through a fixed joint 5 and a sliding bearing 6 where the space 3 between the outer 1 and the inner tank 2 is filled with a material consisting of hollow microspherical particles of sodium borosilicate and synthetic silicon.

The present invention refers to a liquefied gas tank with a significantly higher holding time as well as a method of vacuuming space 3 between the outer 1 and the inner tank 2. The liquefied gas tank is used to store liquefied gases, primarily LNG. The solution is based on the innovative design of a liquefied gas tank in combination with a material used as an insulator located in space 3 between the outer 1 and the inner tank 2. According to the international patent classification the present invention belongs to subgroup F17C3/08—Containers which hold or store compressed, liquefied or solidified gases with non-pressurized vessels and using vacuum as thermal insulator and subgroup F16L59/08—Thermal insulation in general, through preventing heat transfer by non-contact radiation.

Thermal insulation of liquefied gas tanks can also be performed with multilayer (MLI), a material consisting of several layers of aluminium foil and glass fibres. Usually, only the flat tubular part of the inner tank is insulated, while the part of the dome-sphere remains uninsulated due to the specific shape of the dome-sphere. This increases the “heat leak” of liquefied gas tanks designed in this way, which reduces the holding time of the liquefied gas tank. The solution according to the invention implies uniform insulation of the inner container including the entire surface of the dome-sphere.

The vacuum space of the liquefied gas tank is only partially filled with MLI and it is located on the wall of the inner tank and all for the reason of allowing the netting of the inner tank into the outer tank. In this process, the MLI with its thickness occupies only 10% of the total space between the inner and outer tank while the rest of the space between the outer and inner tank remains empty. This process of placing the MLI on the inner tank is delicate, time consuming and expensive. In contrast, in the present patent, the entire vacuum space-distance between the inner and outer tank is completely evenly filled with microspheres, which increases the comparative thermal performance of the microspheres in comparison to the MLI. In the case of vacuum loss in the space between the outer and inner tank, the performance of microspheres as an insulating material in comparison to MLI is far less negative.

Document EP 0 012 038 discloses a liquefied gas tank that uses the vacuum as a thermal insulator using composite spheres consisting of plastic resin and glass or plastic spheres with a diameter of 80 to 160 microns, with a ratio of plastic resin to microspheres greater than 1:1 by volume and wherein said composite spheres have a diameter of 0.125 to 1.5 inches.

Document GB 705 217 discloses a cryogenic container that uses perlite in addition to vacuum as an insulator.

However, since spheres with a larger active surface bind gas and steam to each other, there is an increase in pressure due to the release of gas and steam and also due to moisture present in the particles used as insulators, which leads to a reduction in holding time. In document EP 0 012 038 a plastic resin is used to prevent or delay the release of moisture.

The transport of the liquefied gas is carried out in tanks in the form of a cryogenic liquid at a temperature below the boiling point. Each liquefied gas, as well as LNG, evaporates at temperatures above the boiling point and a boil-off (BOG) process occurs. It occurs as a consequence of the influence of ambient heat on the stored liquefied gas in the tank, i.e. its heat leak and it directly depends only on the quality of the tank insulation. The resulting vapours must be vented to avoid an increase in pressure in the tank and thus damage to its mechanical structure. Such venting represents a direct commercial impact on the preservation of the amount of liquefied gas as a valuable cargo in the tank, and there is a tendency for there to be no venting at all or to delay it as much as possible.

Document GB980 188 discloses folded containers for the purpose of preventing heat leak.

Document U.S. Pat. No. 5,702,655 discloses the introduction of a powder insulator between an inner and an outer liquefied gas storage vessel. The powder material is introduced with water and then dried with the help of high-temperature gas which is introduced into the inner vessel. The procedure itself is expensive and time consuming and with an uncertain outcome.

Therefore, the objective technical problem whose solution is disclosed in the present patent application is to minimize the heat leak and maximize the holding time relative to the known solutions. The solution of the present invention achieves a holding time of 82 days, which is a significantly better result compared to existing solutions. FIG. 3 shows that the holding time for containers according to the present invention is significantly longer than the known solutions under the same measuring conditions—the same ambient temperature conditions of 30° C. and the safety valve in the tank set to a maximum pressure of 6.0 bar. Holding time was measured for cryogenic containers with multilayer, for cryogenic containers with perlite, for cryogenic containers with composite spheres and cryogenic containers according to the present invention. The measurement is performed as follows to measure the time that will elapse from filling the liquefied gas canister until the liquefied gas pressure, under equilibrium conditions, reaches the level of the lowest control valve or pressure relief valve, in conditions where the tank is exposed to an ambient temperature of 30° C. and charged to its maximum allowable charge density with that liquefied gas.

The solution is based on the innovative design of a tank for storage and distribution of liquefied gas in combination with the material in the form of hollow microspherical particles 4 used as an insulator and located in space 3 between the outer 1 and inner tank 2. The above mentioned tank is designed in a way that the outer 1 and the inner container 2 touch only through a fixed connection 5 and a sliding bearing 6 made of two pipes of which the pipe 7, welded on the outer side of the dome-sphere 11 of the inner container 2, enters the pipe 8 welded on the inner side of the dome-sphere 12 of the outer container 1. Therefore, in contrast to the known solutions, the solution according to the invention does not contain additional supports 13 through which heat is transferred by conduction. This reduces the rate of change-equalization of temperature between the two tanks and thus slows down the evaporation (boil-of) of the liquefied gas, which ultimately results in a longer retention time of the liquefied gas in the tank. Furthermore, thanks to the construction and use of microspherical particles described above, it is possible to increase space 3 between the outer 1 and the inner tank 2 to maximize the insulation thickness or the insulation effect in vacuum conditions. Surprisingly, the liquefied gas tank according to the invention and without additional supports met all the prescribed norms for intermodal transport related to fire safety standards and collision and stress standards.

In particular, the liquefied gas tank according to the present invention meets the following standards:
IMDG-UN TANK T75, International Maritime Organization, IMDG Code, Amendment 36/12, 2012 Edition
RMF/DIVISION 411: F/BV/13/082-T75, French Maritime Regulation, Division 411
RID/ADR: F/7219/B V/13, Regulation concerning the International transportation of Dangerous goods by Rail—Chapter 6.7, 2013 Edition, European Agreement for the International transportation of Dangerous goods by road-Chapter 6.7, 2013 edition.

In addition, the liquefied gas tank is covered by the following certificates issued by Bureau Veritas, Paris, France:
Report BVCT 1370282/V Revision 0,
RID/ADR Prototype Agreement Certificate of Portable Tank, F/7219,
Technical Data, Portable Tanks (6.7).

Furthermore, thanks to the construction and use of microspherical particles described above, it is possible to increase space 3 between the outer 1 and the inner container 2. Specifically, the distance between the outer 1 and the inner container 2 is increased from 60-70 mm to more than 150 mm.

The goal is to align the optimal ratio of tank dimensions with regard to standards in intermodal transport and the maximum amount of cargo (media) that can be transported in this case with regard to total gas losses per transport.

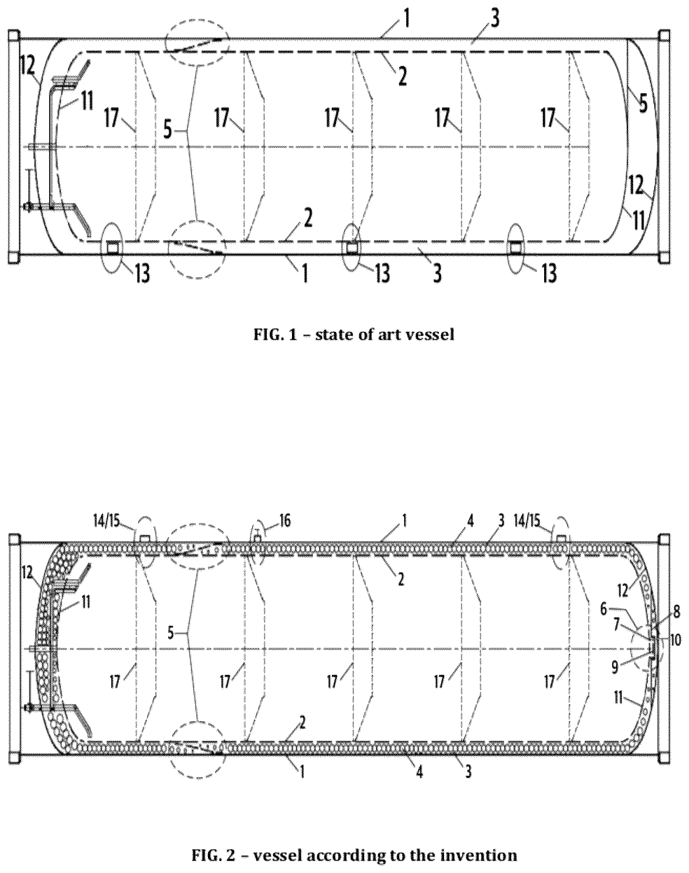

FIG. 1 shows a liquefied gas tank according to the prior art;

FIG. 2 shows a liquefied gas tank according to the invention;

FIG. 3 shows the results of a comparative test of the holding time duration of the solution according to the invention in relation to the holding times from the prior art;

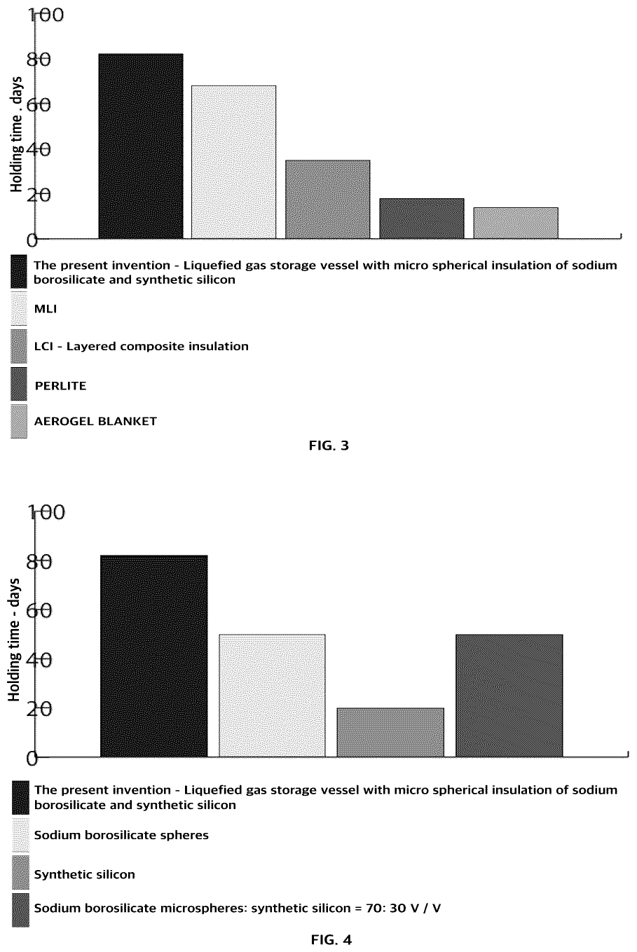

FIG. 4 shows the results of the holding time solution according to the invention in relation to the holding time of sodium borosilicate glass and synthetic silicon.

### CALL SIGNS HAVE THE FOLLOWING MEANING

1—external tank
2—inner tank
3—space between the outer and inner tank
4—hollow microspherical particles
5—fixed connection
6—sliding bearing
7—pipe welded on the outside of the dome-sphere of the inner tank
8—pipe welded on the inner side of the dome-sphere of the outer tank
9—sliding part of the sliding bearing of the inner tank
10—non-metallic sliding material with low heat transfer coefficient
11—dome-sphere of the inner tank
12—dome-sphere of the outer container
13—supports
14—charging/irradiation opening
15—charging/irradiation opening
16—vacuum valve
17—barrier against liquid splashing

Surprisingly, despite the teachings of Document EP 0 012 038, the present invention uses hollow microspherical particles 4 without plastic resins that prevent, i.e. delay the release of moisture, and contrary to expectations achieve better results in terms of length of holding time and heat leak, which is clearly shown in FIG. 3.

The holding time was also measured in case only sodium borosilicate in the form of hollow microspherical particles 4 is used as a thermal insulator in space 3 between the outer 1 and the inner tank 2 and it is 30 days. In case synthetic silicon holding is used as a thermal insulator, the time is even shorter. The results of the holding time for sodium borosilicate or synthetic glass in relation to the holding time according to the present invention are shown in FIG. 4.

The liquefied gas storage and distribution tank is designed in such a way that the outer 1 and the inner tank 2 touch only through a fixed joint 5 and a sliding bearing 6 where the space 3 between the outer 1 and the inner tank 2 is filled with a material consisting of hollow microspherical particles of sodium borosilicate and synthetic silicon. The fixed joint 5 is made of sheet metal not more than 3 mm thick in the form of an elongated cone, while the sliding bearing 6 is made of two pipes of which the pipe 7 welded on the outside of the dome of the inner tank 2 enters the pipe welded on the inside dome of the outer tank 8. As for the sliding part of the bearing 9 of the inner tank 2, it rests on a non-metallic sliding material whose heat transfer coefficient is very small and is fixed to the inner side of tube 8 of outer tank 1. Said non-metallic sliding material is selected from the group consisting of but not exhaustive-commercially available polycarbonate materials.

On the other hand, the hollow microspherical particles 4 of sodium borosilicate and synthetic silicon according to the invention have a mean particle diameter of less than 105 micrometers, a maximum particle diameter of less than 190 micrometers and a thermal conductivity of 0.0489 W/mK or less and a density of 0.08 g/cm3 or less. The hollow microspherical particles 4 of sodium borosilicate and synthetic silicon have a thermal conductivity of 0.0489 W/mK or less. The ratio of sodium borosilicate to synthetic silicon is equal to or greater than 80:20 by volume, and in a preferred embodiment of the invention is 90:10 by volume.

The above solutions allow the distance between the inner 2 and the outer tank 1 to be increased from 60-70 mm to above 150 mm. In a specific embodiment of the invention, the distance is increased to 152 mm.

In a particularly advantageous embodiment of the invention, a low thermal conductivity coating is applied to the outer shell of the outer tank, which represents a thermal barrier and therefore reduces the transfer of ambient temperature by convection to the liquefied gas tank.

Through two openings 14 and 15, the microspherical insulating material is poured. One of the openings is used for charging while the other is the irradiation opening. The function of the opening alternates with each loaded amount of 1 m³ of microspheres, all with the goal of their more even distribution in the insulation space. When the opening is in the function of a vent, then a filter system is mounted on it, both to save the insulating material that could come out in the venting process and to prevent environmental contamination with microspheres exiting through the vent space.

The transport of microspheres from the basic package in which the microspheres are delivered is carried out with low pressure and high volume injector in the presence of dry nitrogen gas, all to reduce moisture intake in the space 3 between the tanks. The injector sucks the microspheres from the delivery tank and transports them to the space between the tanks via nitrogen gas under pressure. Ultimately, due to the fluid characteristics of the microspheres and the loading process, the insulating microspheres completely and in a uniform density of 80 kg/m3 fill all the free space between the outer and inner tank. The loading and venting openings are hermetically closed after the microspheres are loaded.

The process of vacuuming the space 3 is carried out through a vacuum valve 16 installed on the formwork of the outer tank. Vacuuming is carried out in three to four steps, where the dynamics of vacuuming in terms of capacity and speed is strictly controlled to avoid the creation of moisture and thus frost in the vacuum space. In particular, from the first to the last step, the vacuuming is performed by using a maximum capacity vacuum pump in the first step and using smaller and smaller pumps through the steps to use the lowest capacity pump in the last step (third or fourth).

1. A liquefied gas storage and distribution tank, characterized in that the outer (1) and inner tank (2) touch only via a fixed connection (5) and a sliding bearing (6) and that the space (3) between the outer (1) and the inner a container (2) is filled with a material consisting of hollow microspherical particles of sodium borosilicate and synthetic silicon.

2. The liquefied gas storage and distribution tank according to claim 1, characterized in that the fixed connection (5) is made of sheet metal not more than 3 mm thick in the form of an elongated cone, while the sliding bearing (6) is made of two pipes of which pipe (7) welded on the outside of the floor of the inner tank (2) enters the pipe welded on the inside of the floor of the outer tank (8).

3. The liquefied gas storage and distribution tank according to claim 2, characterized in that the sliding part of the bearing (9) of the inner tank (2) rests on a non-metallic sliding material selected from the group consisting of but not exhaustive-commercially available polycarbonate materials and which is fixed to the inside of the tube (8) of the outer container (1).

4. The liquefied gas storage and distribution tank according to claim 1, characterized in that the hollow microspherical particles (4) of sodium borosilicate and synthetic silicon have an average particle diameter of less than 105 micrometres, a maximum particle diameter of less than 190 micrometres and a thermal conductivity of 0.0489 (W/mK), and a density of 0.08 g/cm3 or less.

5. The liquefied gas storage and distribution tank according to claim 4, characterized in that the hollow microspherical particles (4) of sodium borosilicate and synthetic silicon have a thermal conductivity of 0.0489 W/mK or less.

6. The liquefied gas storage and distribution container according to claim 5, characterized in that the ratio of sodium borosilicate to synthetic silicon is equal to or greater than 80:20 by volume, and in a preferred embodiment of the invention 90:10 by volume.

7. The liquefied gas storage and distribution tank according to claim 1, characterized in that the distance between the inner (2) and the outer tank (1) is at least 150 mm.

8. The liquefied gas storage and distribution tank according to claim 7, characterized in that a low thermal conductivity coating selected from the group consisting is applied to the outer shell of the outer tank.

9. An insulation method for liquefied gas storage and distribution tank, characterized in that microspheres are introduced into the space (3) between the outer (1) and inner tank (2) under low pressure by means of a high-volume injector, followed by vacuuming the space (3) via the vacuum valve (16) in three to four steps in such a way that the capacity of the vacuum pumps used from step one to the last step is reduced, followed by the insulation of the outside of the outer tank (1).

10. A liquefied gas storage and distribution container, insulated by the method according to claim 9.
